(19) United States
(12) Patent Application Publication
(10) Pub. No.: US 2007/0014615 A1
(43) Pub. Date: Jan. 18, 2007

(54) Printing apparatus and printing control method

(75) Inventors: Hiroshi Kasayama, Tokyo (JP); Kazuo Onodera, Yokohama-shi (JP); Moriyoshi Inaba, Tokyo (JP)

Correspondence Address: FITZPATRICK CELLA HARPER & SCINTO, 30 ROCKEFELLER PLAZA, NEW YORK, NY, 10112, US

(73) Assignee: CANON FINETECH INC., Joso-shi (JP)

(21) Appl. No.: 11/472,342

(22) Filed: Jun. 22, 2006

(30) Foreign Application Priority Data
Jun. 29, 2005 (JP) 2005-190479

(51) Int. Cl. B41J 11/44

(52) U.S. Cl. 400/76; 340/572.1; 340/10.51

(57) ABSTRACT

An object of this invention is to improve an error process when a write error occurs in an RFID tag. According to this invention, a printing control method for a printing apparatus includes a write step of writing predetermined information by communicating with an RFID tag added to each label on a label paper sheet, a printing step of printing a predetermined image to be printed on the surface of the label, and a reception step of receiving one of a first setting for, when an RFID tag write error occurs, stopping writing information in the write step and stopping printing the image to be printed in the printing step, and a second setting for writing the information and printing the image to be printed on a printing medium conveyed after the printing medium to which the RFID tag is added, wherein when the RFID tag write error occurs, the write step and the printing step are executed based on a setting received in the reception step.

### FIELD OF THE INVENTION

The present invention relates to a printing apparatus and a printing control method and, more particularly, to a printing apparatus having an RFID write function of communicating with a printing medium which incorporates an RFID tag and the like, and a printing function of conveying the printing medium to print an image to be printed on the surface of the printing medium using a full-line printhead and the like, and a printing control method for the printing apparatus.

### BACKGROUND OF THE INVENTION

Along with the progress of a semiconductor technology and electronic communication technology, an RFID (Radio Frequency Identification) technique capable of transmitting/receiving electronic information in a noncontact manner has been put into practical use. Recently, an automatic identification system (to be referred to as an “RFID system” hereinafter) using this RFID technique has been developed.

The RFID system generally includes an RFID tag which has an electronic circuit to hold electronic information, and an RFID reader/writer which controls the RFID tag. The RFID system can newly write and add electronic information, can simultaneously communicate with a plurality of the RFID tags, and is almost free from the influence of an obstacle and the like, as its characteristic features. An automatic identification system using barcodes, two-dimensional codes, or the like does not have such characteristic features. Hence, the application of the RFID system has received an attention because of its convenience not only in a field in which automatic identification using barcodes or two-dimensional codes has been difficult to be carried out but also in a field such as the distribution industries in which automatic identification using barcodes or two-dimensional codes has been conventionally carried out.

When a printing medium such as a card or label which incorporates an RFID tag is to be used in the RFID system, an image to be printed must be printed on the surface of the printing medium, and electronic information must be written in the RFID tag in advance. Recently, these operations are not performed by independent apparatuses. A printing apparatus has been used, which has a function of writing electronic information in the RFID tag. That is, the printing apparatus has an RFID tag write function of printing an image to be printed on the surface of the printing medium, and also writing electronic information in the RFID tag.

There are many types of RFID tags depending on the size of a communication antenna and the type of IC chip to be used. The maximum capacity, communication range, communication time, and the like of the RFID tag vary depending on the type of RFID tag.

The conventional printing apparatus having the RFID tag write function generally supports the plurality of types of RFID tags. In order to write electronic information in an RFID tag in accordance with a communication condition which varies depending on the type of RFID tag, the RFID tag attached to the printing medium is generally moved to a position under an RFID antenna on the RFID reader/writer side, and conveyance of the printing medium is stopped.

However, some conventional printing apparatuses can print an image to be printed, without stopping conveyance of the printing medium. When stopping conveyance of the printing medium in order to write electronic information in the RFID tag in such printing apparatus, the overall throughput of the processes decreases.

Especially, in a color printing apparatus which has a plurality of full-line printheads, the plurality of full-line printheads are aligned in the conveyance direction of the printing medium. The color printing apparatus parallelly prints on a plurality of printing media depending on the sizes of the printing media to be used, thereby increasing the throughput.

However, in such color printing apparatus, when conveyance of a printing medium is stopped at a position to communicate with an RFID tag in order to write electronic information in the RFID tag, a next printing medium cannot be fed until the writing process in the RFID tag ends, and conveyance of the printing medium is restarted. Accordingly, the throughput cannot increase. Especially, in printing images to be printed on a label paper sheet on which the printing media (labels) are continuously arranged, the printing medium must be returned for each printing process, thereby further decreasing the throughput.

Under these circumstances, in order to solve the above problem, a printing control method of writing electronic information in an RFID tag without stopping conveyance of a printing medium, i.e., while conveying the printing medium is proposed (e.g., see Jpn. Pat. Appln. KOKAI Publication No. 2002-2026).

However, even in avoiding a decrease in throughput using such printing control method, the throughput inevitably decreases when an error occurs in the RFID tag (when a write error occurs in the RFID tag). This is because when an error occurs in the RFID tag, the error is identified as a write error, a defective printing medium is discriminated from a normal printing medium and delivered from the printing apparatus, and conveyance of the printing medium is stopped.

In the above-described printing control method, a recovery process (error process) for the write error must be manually performed. Accordingly, the printing apparatus must always be monitored, thus posing a problem.

To cope with such problem, even when a write error occurs, electronic information to be written in the printing medium in which the error has occurred in the RFID tag may be written in a next printing medium without stopping conveyance of the printing media. In such method, the error process need not be manually performed even when the write error occurs, thereby minimizing a decrease in throughput because of the error in the RFID tag. However, in this method, it is difficult to discriminate a printing medium in which a write error has occurred from that in which electronic information has been normally written, thus posing another problem.

As described above, the conventional printing apparatus has both advantages and disadvantages in the error process when a write error occurs in the RFID tag.

### SUMMARY OF THE INVENTION

The present invention has been made in consideration of the above problem, and has as its object to improve an error process when a write error occurs in an RFID tag.

More specifically, it is the first object to allow a user to select an error processing method depending on a use condition, and to optimize the error process when an error occurs. It is the second object to easily discriminate an RFID tag in which a write error has occurred, by cutting RFID tags when the write error occurs in the RFID tag.

In order to achieve the above objects, a printing apparatus according to the present invention has the following arrangement. That is, a printing apparatus comprising:

a write unit configured to write predetermined information by communicating with an RFID tag added to each of printing media to be continuously conveyed;

a printing unit configured to print a predetermined image to be printed on a surface of the printing medium; and

a reception unit configured to receive one of a first setting for, when an error occurs during communication with the RFID tag, inhibiting the write unit from writing information on the printing medium to which the RFID tag is added, and inhibiting the printing unit from printing the image to be printed, and a second setting for, when an error occurs during communication with the RFID tag, writing the information and printing the image to be printed on a printing medium conveyed after the printing medium to which the RFID tag is added,

wherein when an error occurs during communication with the RFID tag, the write unit and the printing unit operate based on a setting received by the reception unit.

The present invention can improve an error process to be performed when a write error occurs in an RFID tag.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic view of a printing system in which an inkjet printing apparatus having an RFID tag printing function is connected to a host computer according to a representative embodiment of the present invention;

FIG. 2 is schematic views of a printing medium which incorporates an RFID tag;

FIG. 3 is a sectional side view showing the schematic arrangement of the printing apparatus shown in FIG. 1;

FIG. 4 is a perspective view for schematically explaining alignment of inkjet printheads and an RFID communication antenna which are mounted in the printing apparatus shown in FIG. 1;

FIG. 5 is a block diagram showing the control functional arrangement of the printing apparatus shown in FIG. 1;

FIG. 6 is a view showing the control command system of the printing apparatus shown in FIG. 1;

FIG. 7 is view showing transition of a printing process during RFID tag communication in the printing apparatus according to the first embodiment;

FIG. 8 is a flowchart showing the flow of a printing process in the printing apparatus according to the first embodiment;

FIG. 9 is view showing cutting positions at which printing media are separated when an RFID tag write error occurs in a printing apparatus according to the second embodiment;

FIG. 10 is view showing methods of cutting the printing medium between a series of RFID tags in the printing apparatus according to the second embodiment; and

FIG. 11 is a flowchart showing the flow of a printing process in the printing apparatus according to the second embodiment.

### DETAILED DESCRIPTION OF THE PREFERRED EMBODIMENTS

Preferred embodiments of the present invention will now be described in detail in accordance with the accompanying drawings.

Note that embodiments to be described hereinafter will exemplify a printing system using a printing apparatus with a full-line printhead that adopts an ink-jet scheme.

In this specification, “printing” (which may also be referred to as “print”) means not only processes for forming significant information such as characters, figures, and the like, but also processes for forming images, patterns, and the like on printing media or processing such media irrespective of whether they are significant or insignificant, and whether they are elicited to be visually perceivable by human beings.

Also, “printing media” mean not only paper sheets used in normal printing apparatuses, but also media that can receive ink, such as cloth, plastic films, metal plates, glass, ceramics, wood, skin, and the like (note that in the following embodiments, a printing medium represents a label having an RFID tag, and a band-shaped medium on which the printing media are continuously arranged represents a label paper sheet).

Furthermore, “ink” (which may also be referred to as “liquid”) should be broadly interpreted as in definition of “printing (print)”, and means a liquid which can undergo formation of images, patterns, and the like, processing of printing media, or ink processes (that solidify or make insoluble a color agent in ink to be applied to a print medium) when it is applied onto printing media.

Furthermore, unless otherwise specified, “nozzle” generally means an orifice, a fluid passage which communicates with the orifice, and an element which generates energy used to discharge ink.

[First Embodiment]

<Configuration of Printing System>

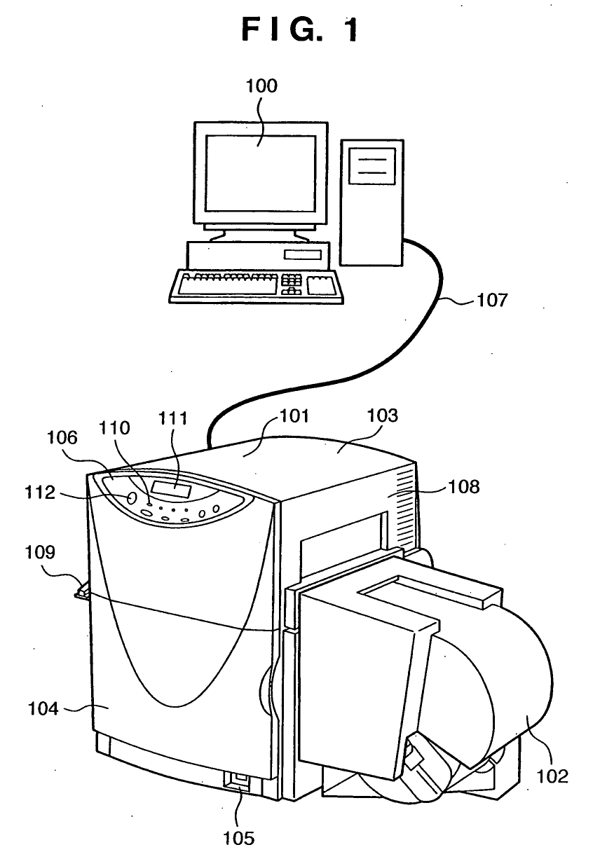

FIG. 1 is a view showing the configuration of a printing system including a printing apparatus according to the first embodiment of the present invention. The printing system includes a color printing apparatus 101 (to be referred to as a printing apparatus hereinafter) using a full-line printhead that adopts an ink-jet scheme, and a host computer 100 (to be referred to as a host hereinafter). As shown in FIG. 1, the printing apparatus 101 is connected to the host 100 via a printer cable 107, and the printing apparatus 101 prints various data processed by the host 100.

The housing of the printing apparatus 101 includes an upper cover 103 which opens/closes a full-line printhead (to be referred to as a printhead hereinafter) (to be described later), RFID communication antenna, and convey unit, a front cover 104 which opens/closes a tank for reserving ink as a print agent to be supplied to the printhead, a paper feeding unit 102 which supplies the printing medium to a printing unit 108, and a cutter 109 which cuts the printing medium conveyed from the printing unit 108.

In FIG. 1, reference numeral 105 denotes a power supply switch of the printing apparatus. Reference numeral 106 denotes an operation panel which includes an input key for setting the operation environment of the printing apparatus 101, and a display means for notifying a user of occurrence of an error in the printing apparatus 101. The operation panel also includes LEDs 110, an LCD 111, and buttons 112.

<Arrangement of Printing Medium>

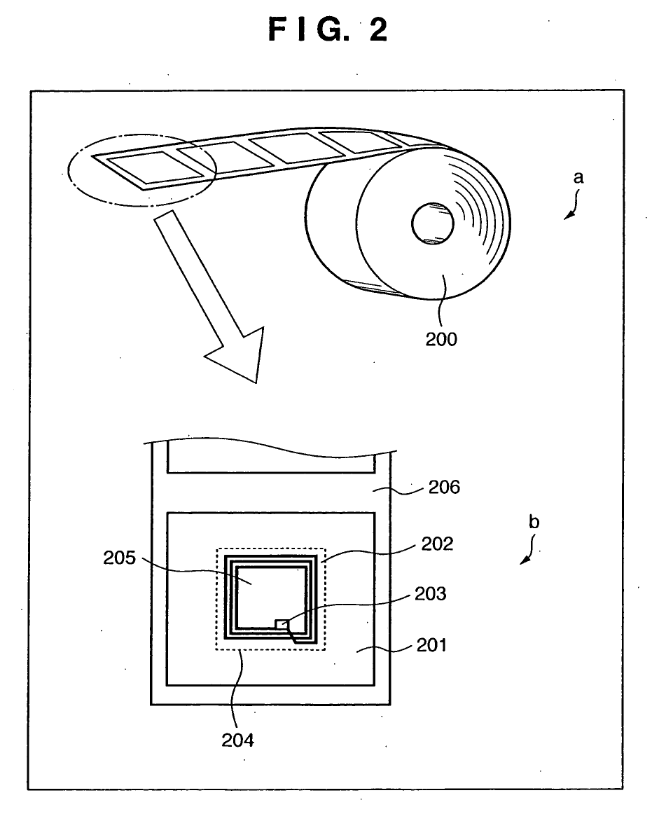

FIG. 2 is schematic views of an RFID tag incorporating continuous label paper sheet 200 on which RFID tag incorporating labels used as the printing media by the printing apparatus 101 are aligned.

As shown in FIG. 2, the RFID tag incorporating continuous label paper sheet 200 has RFID tag incorporating labels (printing media) 201 whose back surfaces are processed to be adhesive, a layout sheet (medium) 206 on which the RFID tag incorporating labels are continuously fixed, and RFID tags 205. Each RFID tag 205 includes an IC chip 203 with a nonvolatile memory for storing electronic information, and a loop antenna 202, and is covered with a paper sheet or PET resin film 204. The RFID tag incorporating label 201 having no power supply generates power by using a radio wave from an RFID communication antenna (to be described later) arranged in the printing apparatus 101. The generated power supply is used as an internal power supply to write, in the RFID tag 205, electronic information transmitted via the RFID communication antenna.

<Hardware Arrangement of Printing Apparatus>

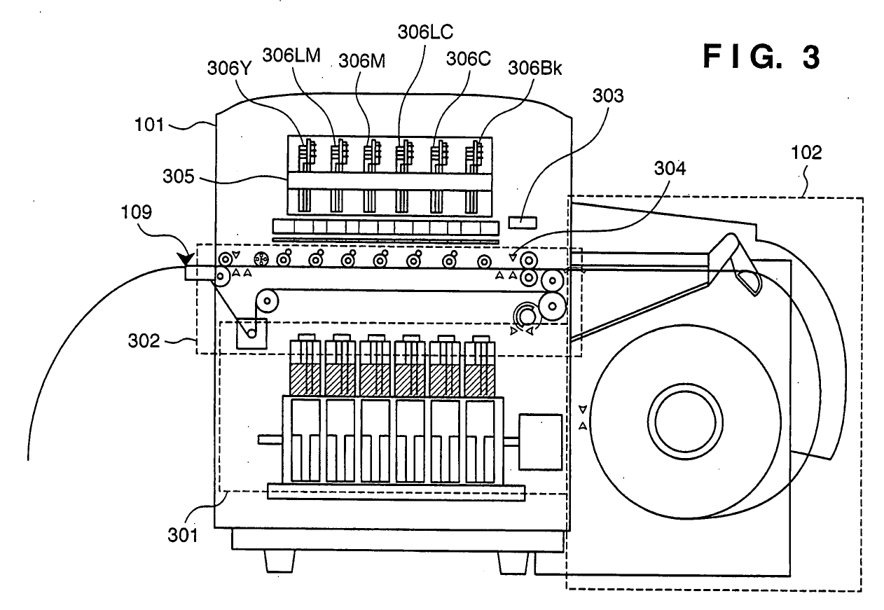

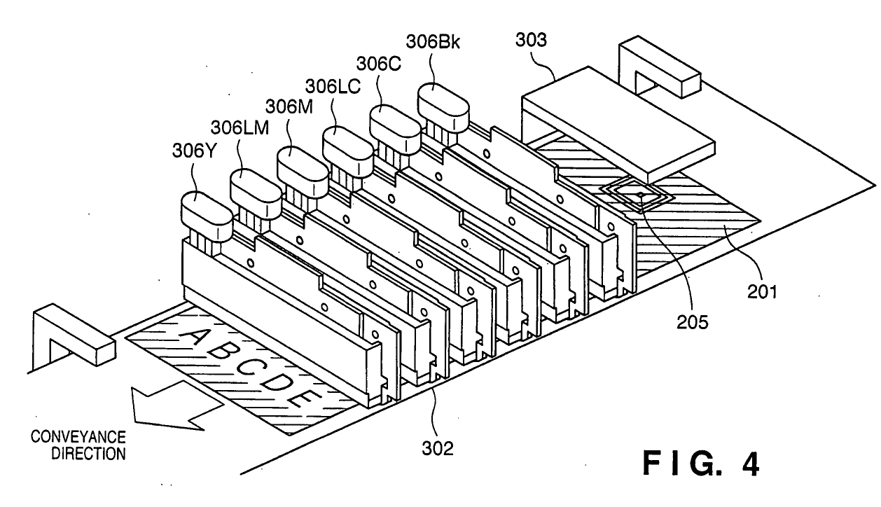

FIG. 3 is a sectional view showing the schematic arrangement of the printing apparatus 101 shown in FIG. 1. FIG. 4 is a perspective view for schematically explaining alignment of printheads and an RFID communication antenna which are used in the printing apparatus 101 shown in FIG. 1.

The printing apparatus 101 includes six full-line printheads to print using six color inks at maximum. As shown in FIGS. 3 and 4, printheads 306Bk, 306C, 306LC, 306M, 306LM, and 306Y for respectively discharging black, cyan, light cyan, magenta, light magenta, and yellow inks are sequentially arranged from the upstream side of the conveyance direction of the printing media. Note that reference numeral 305 generally denotes the six printheads. An RFID communication antenna 303 is also arranged upstream of the printhead 305.

As shown in FIG. 3, in a convey unit 302 arranged under the printhead 305, when the RFID tag incorporating label 201 set in the paper feeding unit 102 is conveyed by the supply method (to be described later) to a print position at which the printhead 305 prints, a TOF sensor 304 manages the position of the RFID tag incorporating label 201. When the RFID tag incorporating label 201 reaches a communication position to communicate with the RFID communication antenna 303, the write of electronic information in the incorporated RFID tag 205 via the RFID communication antenna 303 is started.

When the RFID tag incorporating label 201 is further conveyed and reaches the print position, the inks are discharged from the respective six printheads 306Bk, 306C, 306LC, 306M, 306LM, and 306Y. Accordingly, an image to be printed is printed on the RFID tag incorporating label 201, and the RFID tag incorporating label 201 is finally unloaded to the cutter 109. The cutter 109 cuts the RFID tag incorporating labels 201 subjected to printing, in accordance with an operation setting set by the host 100.

A tank 301 which reserves the inks to be respectively supplied to the printheads 306Bk, 306C, 306LC, 306M, 306LM, and 306Y is detachably fixed under the convey unit 302.

<Control Functional Arrangement of Printing Apparatus>

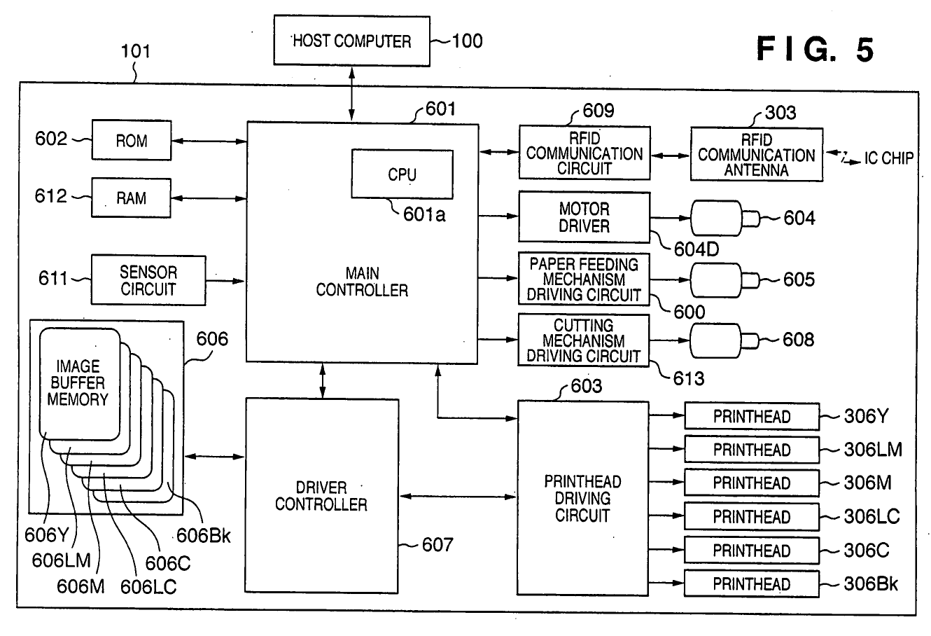

FIG. 5 is a block diagram showing the control functional arrangement of the printing apparatus 101.

In FIG. 5, reference numeral 601 denotes a main controller for controlling the overall printing apparatus. The main controller 601 incorporates a CPU 601a to have a storage control function of storing input data, a data control function, and a setting control function of making various settings required for printing (to be described later). The main controller 601 is connected to the host 100 via an interface (not shown), and can transmit/receive a signal to/from the host 100. Reference numeral 602 denotes a ROM which is connected to the main controller 601 to store a control program and the like. The main controller 601 uses a RAM 612 as a working area to operate based on the control program.

The RAM 612 temporarily stores electronic information which is transferred from the host 100 and is to be written in the RFID tag 205. An RFID communication circuit 609 connected to the main controller 601 writes, in the RFID tag, the electronic information stored in the RAM 612, via the RFID communication antenna 303.

Reference numeral 606 denotes an image buffer memory for storing an image to be printed which is transmitted from the host 100. Reference numerals 606Bk, 606C, 606LC, 606M, 606LM, and 606Y respectively denote image buffer memories for temporarily storing images to be printed of black, cyan, magenta, light magenta, cyan, light cyan, and yellow components.

Reference numeral 603 denotes a printhead driving circuit which drives a heating element (not shown) incorporated in each of the printheads 306Bk, 306C, 306LC, 306M, 306LM, and 306Y. A driver controller 607 connected to the main controller 601 controls the printhead driving circuit 603 in accordance with the image to be printed in the bitmap format for each color component in the image buffer memory 606, thereby printing the image to be printed.

Reference numeral 604D denotes a motor driver 604D which drives a feed motor 604 arranged in the convey unit 302; 600, a driving circuit which drives a motor 605 for driving the roll unit of the paper feeding unit 102; and 613, a driving circuit which drives a motor 608 for driving the cutter 109. These driving circuits are controlled by the main controller 601. Reference numeral 611 generally denotes various sensor circuits including the above-described TOF sensor 304.

<Configuration of Control Command>

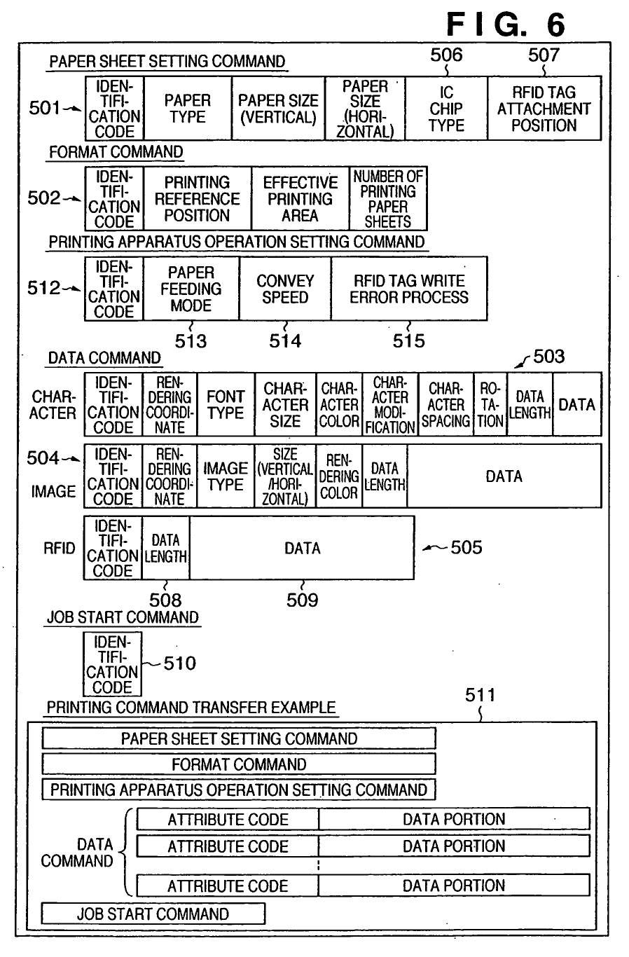

FIG. 6 is a view showing the configurations of various control commands transmitted from the host 100.

As shown in FIG. 6, an identification code for identifying the type of command is allocated at the head of each command, and operands for setting accessory instructions pertaining to each command are sequentially allocated after the identification code. Note that some commands have only identification codes instead of operands.

As control commands, the following commands are available: a paper sheet setting command 501 for setting the size and the like of a printing medium such as a label; a format command 502 for performing the reference setting of print data; a printing apparatus operation setting command 512 for performing the operation settings of the printing apparatus main body; data commands 503, 504, and 505 for respectively setting the detailed pieces of information such as a character, image, and RFID; and a job start command 510 for instructing to stop printing data or start a job.

These commands are output as a command array such as a print command transfer example 511, from the host 100 to the printing apparatus 101.

The type of IC chip 203 in the RFID tag 205 is set in an IC chip type operand 506 of the paper sheet setting command 501, and the size of the RFID tag is set in an RFID tag attachment position operand 507. The paper feeding mode of the printing apparatus is set in a paper feeding mode operand 513 of the printing apparatus operation setting command 512, the convey speed in the printing apparatus is set in a convey speed operand 514, and the processing method to be applied when an RFID tag write error occurs in the printing apparatus is set in an RFID tag write error processing operand 515. For example, in the RFID tag write error processing operand 515, whether to stop or continue conveyance of the printing medium when the RFID tag write error occurs is set, the maximum frequency of error occurrence by which conveyance is continued even when the RFID tag write error occurs is set, and a cutting method to be applied when the write error occurs in an RFID tag is set. The data amount of electronic information to be written in the IC chip 203 is set in a data length operand 508 of the RFID data command 505, and the electronic information is set in a data operand 509.

<Processing Flow in Printing Apparatus>

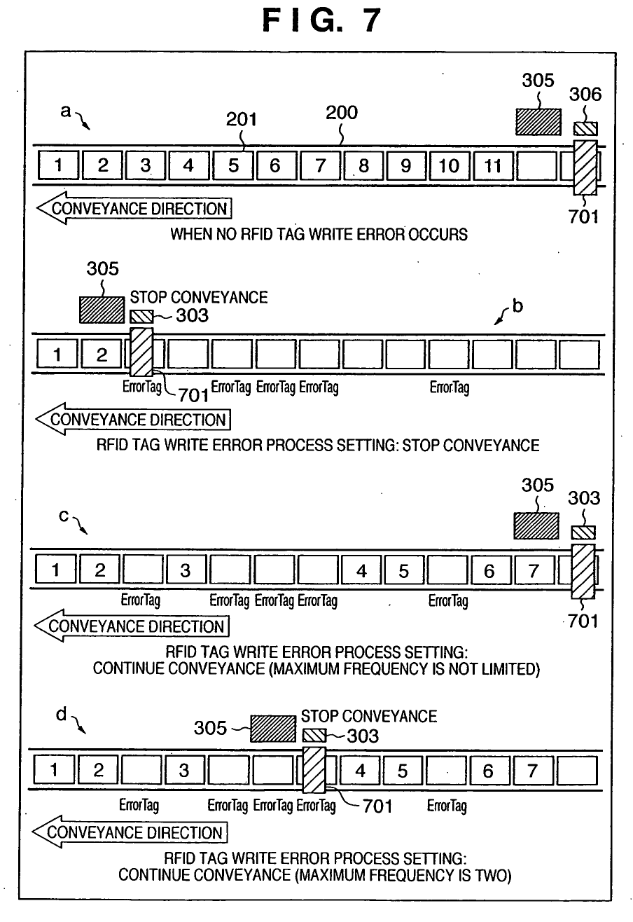

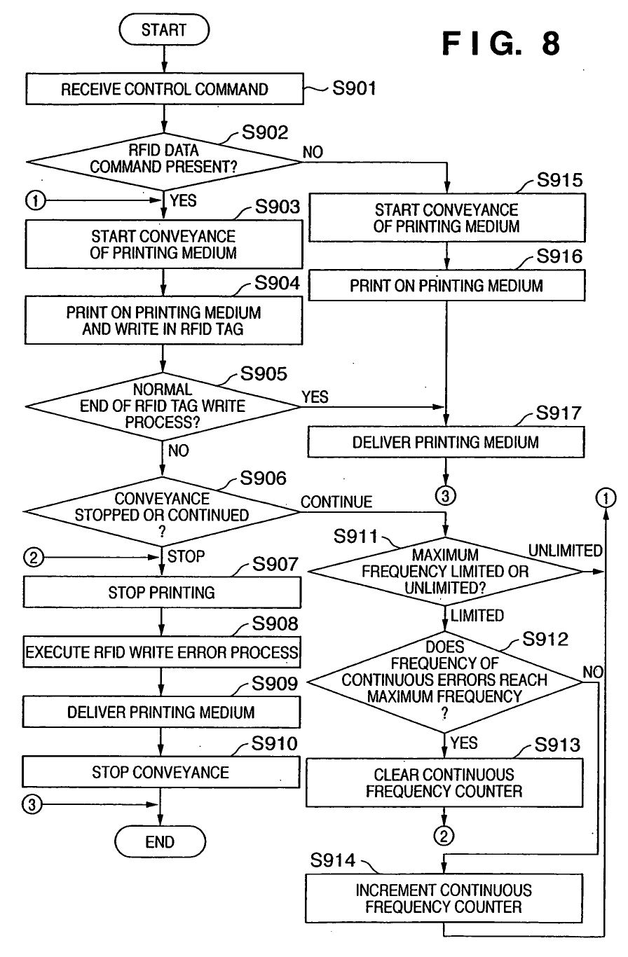

A printing process including writing electronic information in the RFID tag in the printing system with the above-described configuration will be described below with reference to FIG. 7 and FIG. 8.

Reference a in FIG. 7 is a view showing transition of the printing process during RFID tag communication. Reference b in FIG. 7 shows a process in a case wherein an RFID tag write error occurs when the RFID tag write error processing operand 515 is set to stop conveyance of the printing medium. Reference c in FIG. 7 shows a process in a case wherein the RFID tag write error occurs when the RFID tag write error processing operand 515 is set to continue conveyance of the printing medium and when the maximum frequency of error occurrence by which conveyance of the printing medium is continued is not limited. Reference d in FIG. 7 shows a process in a case wherein the RFID tag write error occurs when the RFID tag write error processing operand 515 is set to continue conveyance of the printing medium and when the maximum frequency of error occurrence by which conveyance of the printing medium is continued is two. FIG. 8 is a flowchart showing an error processing selection process when the RFID tag write error occurs. Note that this printing process is implemented when the CPU 601a serving as the processing unit of the printing apparatus 101 executes, e.g., application software stored in the ROM 602.

The present invention will be described along with the following flowchart shown in FIG. 8.

Together with a command for instructing the printing process, the host 100 transmits, to the printing apparatus 101, various parameters such as a print count, a paper size, an operation setting to be executed when the RFID tag write error occurs, and the type of IC chip 203, an image to be printed, and electronic information to be written in the IC chip 203.

Upon activation of the application, a control command is received from the host 100 in step S901. The images to be printed are stored in the image buffer memories 606Bk, 606C, 606LC, 606M, 606LM, and 606Y, and the above-described electronic information is stored in the RAM 612.

Each of the images to be printed and the electronic information contains accessory information representing its attribute. After the control command is received in step S901, the presence/absence of the electronic information is determined in step S902. In this case, the presence/absence of an RFID data command is determined.

When it is determined that the RFID data command is present, i.e., that electronic information to be written in the IC chip 203 is present, the flow advances to step S903 to start conveyance of the printing medium. After starting conveyance of the printing medium, when the printing medium reaches a communication position range 701 under the RFID communication antenna 303, the write of the electronic information in the incorporated RFID tag 205 via the RFID communication antenna 303 is started in step S904. Subsequently, when the printing medium is further conveyed and reaches the print position (immediately under each printhead), the printheads 306Bk, 306C, 306LC, 306M, 306LM, and 306Y discharge the inks to print an image to be printed on the RFID tag incorporating label 201, concurrently with writing electronic information in another RFID tag 205.

After completely writing the electronic information in the RFID tag 205, it is checked in step S905 whether the write process has normally ended. When it is determined that the electronic information has been normally written, and an image to be printed in the next printing medium is present, as shown in reference a of FIG. 7, printing of the image to be printed on the next printing medium is started, and the above-described processes are parallelly executed. Then, after completely printing on the surface of the RFID tag incorporating label 201, the printing medium is conveyed to the cutter 109 in step S917.

On the other hand, when it is determined in step S905 that wiring of electronic information has failed in the RFID tag 205 after some pieces of electronic information can be normally written in the respective printing media, the flow advances to step S906. The operation settings (in the RFID tag write error processing operand 515) which are set by the host 100 and are to be executed when the RFID tag write error occurs will be referred to. When the operation setting indicates that conveyance of the printing medium must be stopped upon occurrence of the RFID tag write error, the flow advances to step S907 to stop printing electronic information in the printing medium in which the error has occurred as shown in reference b of FIG. 7. Furthermore, the flow advances to step S908, and a message representing occurrence of the RFID tag write error is displayed on the LCD 111 in the operation panel 106 to notify the user of occurrence of the error. The printing medium in which the RFID tag write error has occurred is delivered to the cutter 109 in step S909. After that, the printing apparatus stops conveyance of the printing medium in step S910, and is set in a standby state until the user releases the error state.

Note that, after the user releases the error state, the electronic information and image which should be printed when the error has occurred start being written and printed again.

When the operation setting indicates in step S906 that conveyance of the printing medium must be continued even when the RFID tag write error occurs, the maximum frequency of RFID tag write error continuous occurrence (the maximum frequency of error occurrence by which conveyance of the printing medium is continued even when the RFID write error occurs) is confirmed in step S911. When the maximum frequency is not limited, conveyance of the printing medium is not stopped even when the error occurs as shown in reference c of FIG. 7. In this case, the electronic information and print image which should be printed when the write error has occurred are written and printed in the next printing medium.

When the maximum frequency is limited in step S911, the flow advances to step S912 to confirm whether the value of a continuous frequency counter reaches the maximum frequency. If NO in step S912, the continuous frequency counter is incremented, and the flow advances to step S903 to continue writing.

If YES in step S912, the flow advances to step S907 to stop printing. Reference d in FIG. 7 shows an operation to be performed when the maximum frequency is two. When the RFID tag write error occurs for the first time, one write error occurs in an RFID tag, and the next RFID tag is normal. Accordingly, the write process can be continued. On the other hand, when the RFID tag write error occurs for the second time, since three write errors continuously occur in the RFID tags, conveyance of the printing medium is stopped.

When it is determined in step S902 that electronic information to be written in the IC chip 203 is absent (i.e., that the RFID data command is absent), the flow advances to step S915. In this step, conveyance of the printing medium is started without writing the electronic information in the RFID tag. In step S916, the printing apparatus prints on the surface of the printing medium. After this printing process, the printing medium is unloaded to the cutter 109 in step S917. Note that the above-described printing processes are repeated until all images and pieces of electronic information to be printed are completely printed.

As is apparent from the above description, according to the first embodiment, the error processing method to be applied when a write error occurs in the RFID tag can be selected depending on a use condition. Accordingly, the user can optimize the process when an error occurs.

[Second Embodiment]

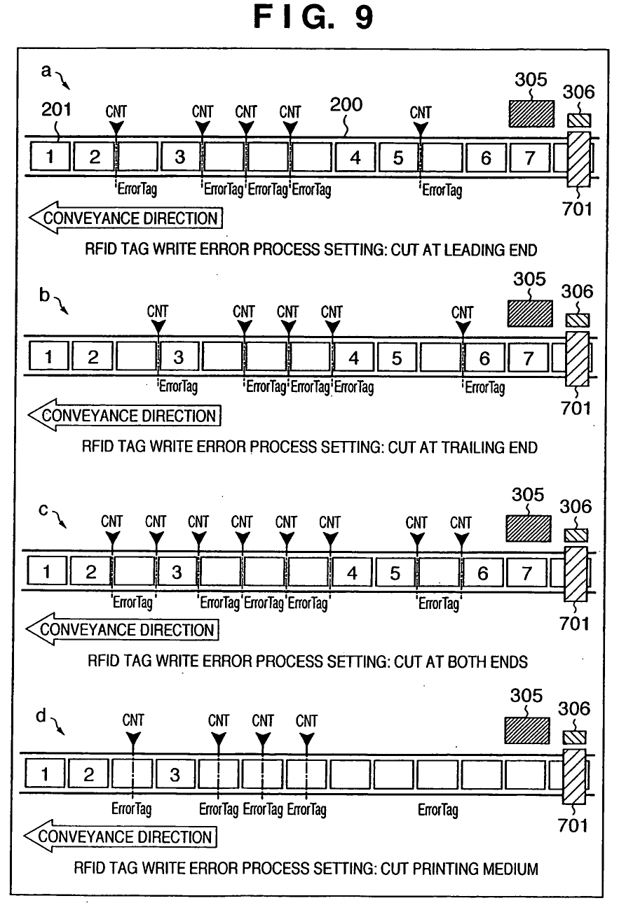

References c and d in FIG. 7 according to the first embodiment, electronic information can be subsequently written in the next RFID tag without stopping conveyance of the printing medium even when a write error occurs in the RFID tag. However, in this case, a printing medium in which the electronic information has been normally written is mixed with that in which the RFID tag write error has occurred. Also, in some cases, it may be difficult to identify a normal printing medium from a defective printing medium. To cope with this problem, the second embodiment avoids mixing of the normal and defective printing media, by cutting printing media. A detailed process in a printing apparatus according to the second embodiment will be described below with reference to FIG. 9 to FIG. 11.

Reference a in FIG. 9 shows a process in a case wherein an RFID tag write error occurs when an RFID tag write error processing operand 515 is set to continue conveyance of printing media, and to cut the printing media at the leading end of a write error tag. Reference b in FIG. 9 shows a process in a case wherein the RFID tag write error occurs when the RFIB tag write error processing operand 515 is set to continue conveyance of the printing media, and to cut the printing media at the trailing end of the write error tag.

Reference c in FIG. 9 shows a process in a case wherein the RFID tag write error occurs when the RFID tag write error processing operand 515 is set to continue conveyance of the printing media, and to cut the printing media at the both ends of the write error tag. Reference d in FIG. 9 shows a process in a case wherein the RFID tag write error occurs when the RFID tag write error processing operand 515 is set to continue conveyance of the printing media, and to cut the write error tag itself of the printing media.

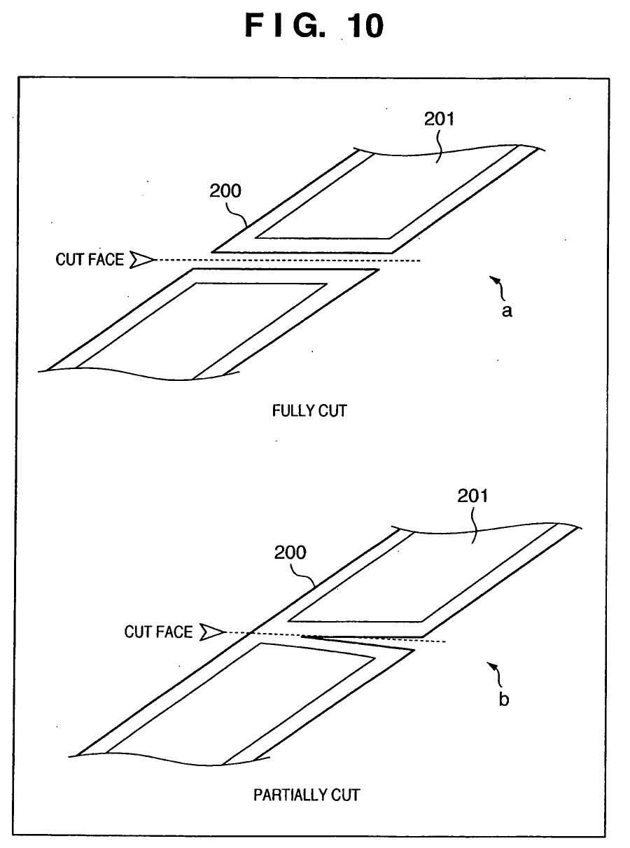

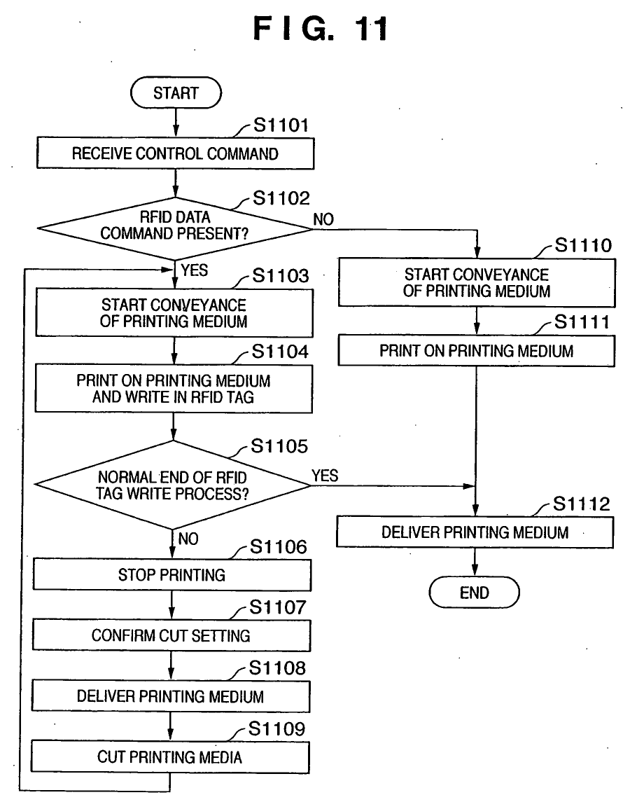

Reference a in FIG. 10 shows a process when the RFID tag write error processing operand 515 is set to completely cut the printing media. Reference b in FIG. 10 shows a process when the RFID tag write error processing operand 515 is set to partially cut the printing media. FIG. 11 is a flowchart showing the flow of selecting a cut process when a write error occurs in the RFID tag. Note that this process is implemented when the CPU 601a serving as the processing unit of a printing apparatus 101 executes, e.g., application software stored in a ROM 602.

The present invention will be described along with the following flowchart shown in FIG. 11.

Together with a command for instructing the printing process, a host 100 transmits, to the printing apparatus 101, various parameters such as a print count, a paper size, a cut setting to be executed when the RFID tag write error occurs, and the type of an IC chip 203, an image to be printed, and electronic information to be written in the IC chip 203.

Upon activation of the application, a control command is received from the host 100 in step S1101. The images to be printed are stored in image buffer memories 606Bk, 606C, 606LC, 606M, 606LM, and 606Y, and the above-described electronic information is stored in a RAM 612.

Each of the images to be printed and the electronic information contains accessory information representing its attribute. After the control command is received in step S1101, the presence/absence of the electronic information is determined in step S1102. In this case, the presence/absence of an RFID data command is determined.

When it is determined that the RFID data command is present, i.e., that electronic information to be printed in the IC chip 203 is present, the flow advances to step S1103 to start conveyance of the printing medium. After starting conveyance of the printing medium, when the printing medium reaches a communication position range 701 under an RFID communication antenna 303, the write of the electronic information in an incorporated RFID tag 205 via the RFID communication antenna 303 is started in step S1104.

Subsequently, when the printing medium is further conveyed and reaches the print position (immediately under each printhead), printheads 306Bk, 306C, 306LC, 306M, 306LM, and 306Y discharge inks to print an image to be printed on an RFID tag incorporating label 201, concurrently with writing electronic information in another RFID tag 205.

After completely writing the electronic information in the RFID tag 205, it is checked in step S1105 whether the write process has normally ended. When it is determined that the electronic information has been normally written, and an image to be printed in the next printing medium is present, printing of the image to be printed on the next printing medium is started, and the above-described processes are parallelly executed. Then, after completely printing on the surface of the RFID tag incorporating label 201, the printing medium is conveyed to a cutter 109 in step S1112.

On the other hand, when it is determined in step S1105 that wiring of electronic information has failed in the RFID tag 205 after some pieces of electronic information can be normally written in the respective printing media, the flow advances to step S1106 to stop printing in the printing medium in which the error has occurred. After stopping printing, the flow advances to step S1107 to confirm a printing medium cut setting which is transmitted from the DC/DC converter 100 and to be applied when the RFID tag write error occurs. The flow then advances to step S1109, and the printing medium is cut in accordance with the cut setting.

According to the printing medium cut setting, a cut position and cut method are defined. As for the cut position, the following settings are available. In reference a of FIG. 9, the printing media are cut at the leading end of the printing medium in which the RFID tag write error has occurred. In reference b of FIG. 9, the printing media are cut at the trailing end of the printing medium in which the RFID tag write error has occurred. In reference c of FIG. 9, the printing media are cut at both ends of the printing medium in which the RFID tag write error has occurred. In reference d of FIG. 9, the printing medium itself in which the RFID tag write error has occurred is cut.

As for the cut method, the following settings are available. In reference a of FIG. 10, the continuous printing media are fully cut at a cut face. In reference b of FIG. 10, the continuous printing media are partially cut at the cut face. In the second embodiment, conveyance of the printing medium is not stopped even when the RFID tag write error occurs, and the flow advances to step S1103 to subsequently write/print, in the next printing medium, the electronic information and image which should be printed when the error has occurred.

On the other hand, when it is determined in step S1102 that the electronic information to be written in the IC chip 203 is absent (i.e., the RFID data command is absent), the flow advances to step S1110 to start conveyance of the printing medium without writing the electronic information in the RFID tag. After that, the flow advances to step S1111 to print the image to be printed on the surface of the printing medium. After this printing process, the printing media are unloaded to the cutter 109. Note that the above-described printing processes are repeated until all images to be printed and pieces of electronic information are completely printed and written.

As is apparent from the above description, according to the second embodiment, when a write error occurs in the RFID tag, the RFID tag in which the error has occurred can be easily identified by cutting the printing medium having the RFID tag in which the error has occurred.

[Third Embodiment]

The first embodiment describes the setting of conveyance of a printing medium when a write error occurs in an RFID tag. The second embodiment describes the cut setting for printing media when a write error occurs in an RFID tag. However, the first and second embodiments may be combined.

In the first and second embodiments, a printing apparatus having a full-line printhead that adopts an ink-jet scheme is described. However, the present invention can also be applied to a printing apparatus with a printhead that adopts a scheme other than the ink-jet scheme, i.e., a thermal printing apparatus, thermal transfer printing apparatus, electrophotographic printing apparatus, or monochrome printing apparatus.

[Other Embodiment]

In the first embodiment, a label printing apparatus using a long printhead which adopts an ink-jet scheme is exemplified. However, the printing apparatus is not particularly limited as far as the printing apparatus has a function of communicating with an RFID tag capable of writing/reading electronic information.

For example, the printing apparatus may be a card printing apparatus which incorporates an RFID communication driver for communicating with an RFID tag incorporated in a plastic card, cut paper sheet, or the like as a printing medium, or a thermal transfer printing apparatus which incorporates an RFID communication driver for communicating with an RFID tag incorporated in an ink ribbon or the like as the printing medium. The present invention is not limited to these printing schemes.

The printing apparatus is not particularly limited as far as the printing apparatus includes a device for writing electronic information in an RFID tag incorporated in the printing medium, and a device for reading the electronic information from the RFID tag incorporated in the printing medium. The present invention is not limited to these RFID communication apparatuses.

The position of a communication antenna is not limited to the upstream side of the printhead above a printing medium. The communication antenna may be arranged on the upstream side of the printhead under the printing medium, the downstream side of the printhead (under the printing medium), the downstream side of the printhead above the printing medium, or the upstream side of the printhead under the printing medium.

An RFID communication driver capable of communicating with the RFID tag may be replaced from a target RFID tag to change a method of checking a memory, or the capacity for checking the memory depending on the target RFID tag.

The RFID tag to be used is not limited to one, and an RFID communication driver capable of communicating with a plurality of types of RFID tags may be arranged to change a method of checking a memory, or the capacity for checking the memory depending on the target RFID tag.

The present invention can be applied to a system constituted by a plurality of devices, or to an apparatus comprising a single device. Furthermore, it goes without saying that the present invention can also be applied to a case wherein a storage medium storing software program codes for realizing the functions of the above-described embodiment is supplied to a system or apparatus, and the computer (or a CPU or an MPU) of the system or apparatus reads out and executes the program codes stored in the storage medium.

In this case, the program codes read out from the storage medium realize the functions of the above-described embodiment by themselves, and the storage medium storing the program codes constitutes the present invention. As a storage medium for supplying the program codes, for example, a floppy® disk, hard disk, optical disk, magnetooptical disk, CD-ROM, CD-R, magnetic tape, nonvolatile memory card, ROM, download via a network, or the like can be used.

The functions of the above-described embodiment are realized not only when the readout program codes are executed by the computer but also when the OS running on the computer performs part or all of actual processing on the basis of the instructions of the program codes.

The functions of the above-described embodiment are also realized when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

The present invention is not limited to the above embodiments and various changes and modifications can be made within the spirit and scope of the present invention. Therefore, to apprise the public of the scope of the present invention, the following claims are made.

This application claims the benefit of Japanese Application No. 2005-190479 filed on Jun. 29, 2005, which is hereby incorporated by reference herein in its entirety.

What is claimed is:

1. A printing apparatus comprising:
a write unit configured to write predetermined information by communicating with an RFID tag added to each of printing media to be continuously conveyed;
a printing unit configured to print a predetermined image to be printed on a surface of the printing medium; and
a reception unit configured to receive one of a first setting for, when an error occurs during communication with the RFID tag, inhibiting said write unit from writing information on the printing medium to which the RFID tag is added, and inhibiting said printing unit from printing the image to be printed, and a second setting for, when an error occurs during communication with the RFID tag, writing the information and printing the image to be printed on a printing medium conveyed after the printing medium to which the RFID tag is added,
wherein when an error occurs during communication with the RFID tag, said write unit and said printing unit operate based on a setting received by said reception unit.

2. The apparatus according to claim 1, further comprising a measurement unit configured to measure a frequency of occurrence of continuous errors when errors occur during communication with the RFID tag,
wherein when the frequency measured by said measurement unit exceeds a predetermined value even if a setting unit performs the second setting, said write unit and said printing unit stop writing the information and printing the image to be printed.

3. A printing apparatus comprising:
a convey unit configured to convey a band-shaped medium on which printing media to which RFID tags are added are continuously arranged;
a write unit configured to write predetermined information by communicating with the RFID tag;
a printing unit configured to print a predetermined image to be printed on a surface of the printing medium; and
a cutting unit configured to cut the band-shaped medium at a predetermined position in order to identify the printing medium to which the RFID tag is added, when an error occurs during communication with the RFID tag.

4. The apparatus according to claim 3, wherein said cutting unit cuts the band-shaped medium at a position on a downstream side in a conveyance direction of the printing medium to which the RFID tag is added.

5. The apparatus according to claim 3, wherein said cutting unit cuts the band-shaped medium at a position on an upstream side in a conveyance direction of the printing medium to which the RFID tag is added.

6. The apparatus according to claim 3, wherein said cutting unit cuts the band-shaped medium at a position on a downstream side in a conveyance direction, and a position on an upstream side in the conveyance direction of the printing medium to which the RFID tag is added.

7. The apparatus according to claim 3, wherein said cutting unit cuts the band-shaped medium together with the printing medium at a position of the printing medium to which the RFID tag is added.

8. The apparatus according to claim 4, wherein said cutting unit completely cuts the band-shaped medium in a widthwise direction.

9. The apparatus according to claim 4, wherein said cutting unit partially cuts the band-shaped medium in a widthwise direction.

10. The apparatus according to claim 3, further comprising a reception unit configured to receive a setting of a cut method performed by said cutting unit.

11. A printing control method for a printing apparatus comprising:
a write step of writing predetermined information by communicating with an RFID tag added to each of printing media to be continuously conveyed;
a printing step of printing a predetermined image to be printed on a surface of the printing medium; and
a reception step of receiving one of a first setting for, when an error occurs during communication with the RFID tag, stopping, in the write step, writing information on the printing medium to which the RFID tag is added, and stopping, in the printing step, printing the image to be printed, and a second setting for, when an error occurs during communication with the RFID tag, writing the information and printing the image to be printed on a printing medium conveyed after the printing medium to which the RFID tag is added,
wherein when an error occurs during communication with the RFID tag, the write step and the printing step are executed based on a setting received in the reception step.

12. A printing control method for a printing apparatus comprising:
a convey step of conveying a band-shaped medium on which printing media to which RFID tags are added are continuously arranged;
a write step of writing predetermined information by communicating with the RFID tag;
a printing step of printing a predetermined image to be printed on a surface of the printing medium; and
a cutting step of cutting the band-shaped medium at a predetermined position in order to identify the printing medium to which the RFID tag is added, when an error occurs during communication with the RFID tag.

13. A storage medium storing a control program for causing a computer to execute the printing control method of claim 11.

14. A control program for causing a computer to execute the printing control method of claim 11.

15. A storage medium storing a control program for causing a computer to execute the printing control method of claim 12.

16. A control program for causing a computer to execute the printing control method of claim 13.
